(19) United States
(12) Patent Application Publication
(10) Pub. No.: US 2026/0324939 A1
(43) Pub. Date: Oct. 22, 2026

(54) DISHWASHER

(71) Applicant: LG Electronics Inc., Seoul (KR)

(72) Inventors: Hwa Suk SHIM, Seoul (KR); Sangwoog CHO, Seoul (KR); Yongnam KIM, Seoul (KR); Sung Hyun PARK, Seoul (KR); Jin Won KANG, Seoul (KR); Min Kyu OH, Seoul (KR)

(21) Appl. No.: 19/108,644

(22) PCT Filed: Jul. 26, 2024
(86) PCT No.: PCT/KR2024/010922

§ 371 Date: Mar. 4, 2025

(30) Foreign Application Priority Data
Jul. 28, 2023 (KR) 10-2023-0098803
Feb. 16, 2024 (KR) 10-2024-0022972

(51) Int. Cl. A47L 15/42; A47L 15/22; F21V 33/00; F21Y 115/10

(52) U.S. Cl. CPC A47L 15/4257; A47L 15/22; A47L 15/4293; F21V 33/0044; F21Y 2115/10

(57) ABSTRACT

The present invention relates to a dishwasher in which a cover part as a means for opening or closing a handle part provided in a shape of concavely recessed toward the inside of a door is disposed so that the handle part is configured to be automatically opened only when necessary such when opening or closing the door, thereby preventing external foreign substances such as dust from being accumulated on the handle part to maintain a clean state thereof.

### CROSS-REFERENCE TO RELATED APPLICATIONS

This application is a National Stage application under 35 U.S.C. §371 of International Application No. PCT/KR2024/010922, filed on Jul. 26, 2024, which claims the benefit of Korean Patent Application No. 10-2023-0098803, filed on Jul. 28, 2023, and Korean Patent Application No. 10-2024-0022972, filed on Feb. 16, 2024. The disclosures of the prior applications are incorporated by reference in their entirety.

### TECHNICAL FIELD

The present disclosure relates to a dish washer, and more particularly, to a dish washer including a door, a handle concavely recessed toward an inside of the door, and a cover configured to be automatically opened based on the door being used.

### BACKGROUND

A dish washer is a device which sprays washing water such as water to a wash target such as tableware, cooking utensils, and the like accommodated therein to wash the wash target. In some cases, the washing water used for washing the wash target may contain a detergent.

For instance, the dish washer may include a washing bath having a washing space therein, a storage part accommodating the wash target in the washing bath, a spray arm spraying the washing water to the storage part, and a sump storing an amount of water therein and supplying the washing water to the spray arm.

By using this dish washer, the time and effort to wash tableware and other wash target after a meal can be reduced, contributing to user convenience.

In some cases, the dish washer may perform a washing process of washing the wash target, a rinsing process of proceeding with the rinsing for the wash target, and a drying process of drying the wash target that has been washed and rinsed.

A user may open and close the door to store the tableware inside the dish washer before these processes start, and to take out the washed and dried tableware after these processes have been completed.

The dish washer may include a handle to facilitate the opening and closing of this door.

In some cases, a dish washer may have a recessed handle provided on the door to be gripped when opening and closing the door. For instance, the handle may be provided in the form of a grip groove recessed from the front surface of the door toward the rear side to a predetermined depth. The handle may be recessed toward the inside of the door without a separate cover or the like, and it remains exposed to the outside at all times.

Therefore, the structure of the handle may be susceptible to the accumulation of external foreign substances such as dust in the recessed part for the gripping, and a frequent cleaning of the handle may cause inconvenience to the user.

In some cases, the light source may be blocked by foreign substances accumulated in the handle, where the foreign substances may become more noticeable by the light source.

### SUMMARY

The present disclosure describes a dish washer including a handle provided in a concavely recessed shape toward the inside of a door to be automatically opened based on the door being used. For example, a cover is configured to open and close the handle to help prevent or reduce the accumulation of external foreign substances such as dust in the handle to maintain a clean state and improve user convenience.

The present disclosure further describes a dish washer configured to cause the cover to close the handle in a situation where the handle is not being used, and configured to create a sense of unity between the front end surface of the cover and the front surface of the door, thereby improving the aesthetics of the outer appearance of the dish washer.

The present disclosure further describes a dish washer including a light source module that is disposed inside the handle, where the front surface of the cover acts as a reflective surface of visible light irradiated from the light source module, thereby allowing the user to immediately and visually recognize the operational status of the cover to improve convenience for the user and enhance the aesthetic feeling for the user.

According to one aspect of the subject matter described in this application, a dish washer includes a tub that defines a washing space configured to accommodate tableware, the tub having an open front side, a door configured to rotate relative to the tub to thereby open and close the open front side of the tub, the door having an opening defined at a front surface of the door, a handle that includes a gripping groove that extends from the opening in the front surface of the door toward an inside of the door, the gripping groove being configured to be gripped by a user to open and close the door, a cover configured to rotate toward the inside of the door relative to the front surface of the door to thereby open and close the opening of the door, and a light source that is disposed inside the door and faces the gripping groove, the light source being configured to irradiate visible light toward at least a portion of the gripping groove.

Implementations according to this aspect can include one or more of the following features. For example, the gripping groove can include a horizontal groove that extends from the opening of the door rearwardly in a horizontal direction, and a vertical groove that extends from an upper end of the horizontal groove upwardly in a vertical direction, the vertical groove being disposed rearward relative to the opening of the door, where the light source is disposed forward relative to the vertical groove.

In some implementations, the light source can be disposed between the opening of the door and the vertical groove. In some examples, the light source can be disposed at a height corresponding to the upper end of the horizontal groove. In some implementations, a lower end of the light source can be disposed inside the door such that no part of the light source protrudes to an upper end surface of the horizontal groove. For instance, the lower end of the light source can be flush with the upper end surface of the horizontal groove.

In some implementations, the light source can extend linearly along an extension direction of the opening of the door. In some examples, a width of the light source in a left-right direction of the door can be greater than a width of the gripping groove in the left-right direction. In some examples, a width of the light source in a left-right direction of the door can be less than a width of the opening in the left-right direction. In some examples, a width of the light source in a left-right direction of the door can be less than a width of the cover in the left-right direction.

In some implementations, the dish washer can include a cover driver configured to rotate the cover between a forwardmost position of the cover and a rearmost position of the cover relative to the front surface of the door. For example, the cover driver can include a drive motor that is disposed inside the gripping groove. In some examples, the light source can be configured to turn on before the cover driver moving the cover from the forwardmost position to the rearmost position. In some examples, the light source can be configured to turn on simultaneously with an operation of the cover driver for moving the cover from the forwardmost position to the rearmost position.

In some implementations, the cover is configured to, based on the cover being moved to the rearmost position by the cover driver, reflect a first portion of the visible light toward an outside of the door. In some examples, the cover is configured to, based on the cover being moved to the rearmost position by the cover driver, reflect a second portion of the visible light toward the gripping groove. In some examples, the forwardmost position of the cover can be flush with the front surface of the door.

In some implementations, the light source can be configured to be disposed rearward relative to a rear surface of the cover based on the cover being moved to the forwardmost position by the cover driver.

In some examples, the light source can include a substrate and one or more light emitting diodes that are arranged on the substrate along the opening of the door. In some examples, the light source can be disposed closer to the front surface of the door than to a rear surface of the door.

The dish washer has the effect of preventing or reducing the accumulation of external foreign substances such as dust in the handle to maintain a clean state and improve user convenience, by configuring a handle to be automatically opened when a user opens and closes the door.

In some implementations, the dish washer has the effect of improving the aesthetic feeling of the outer appearance of the dish washer by being configured to create a sense of unity between the front end surface of the cover and the front surface of the door.

In some implementations, the dish washer is configured so that the cover is moved rearward and retracted toward the inside of the door when the handle is opened, thereby reducing the possibility of injury to the user or damage to the cover that would occur when the cover protrudes toward the outside of the door.

In some implementations, the dish washer has the effect of improving convenience for the user and enhance the aesthetic feeling for the user by the front surface of the cover acting as a reflective surface of visible light irradiated from the light source module, thereby allowing the user to immediately and visually recognize the operational status of the cover.

### BRIEF DESCRIPTION OF THE DRAWINGS

FIG. 1 is a front perspective view showing an example of a dish washer.

FIG. 2 is a schematic cross-sectional view of the dish washer illustrated in FIG. 1.

FIG. 3 is a front perspective view illustrating an example of a cover of a dish washer, where the cover is rotated forward to the forwardmost position.

FIG. 4 is a front perspective view illustrating the cover illustrated in FIG. 3 that is moved rearward to the rearmost position.

FIG. 5 is a rear perspective view of the door shown in FIGS. 3 and 4.

FIG. 6 is a partial enlarged view of a vertical cross-section of the door illustrated in FIG. 5.

FIG. 7 is a rear perspective view of the cover and the cover driver illustrated in FIG. 5.

FIG. 8 is an exploded perspective view of the cover and the cover driver illustrated in FIG. 7.

FIG. 9 is a partial enlarged view of FIG. 8.

FIG. 10 is a schematic diagram explaining an example of a sensor configuration for distinguishing between and recognizing a user and a pet through a proximity sensor disposed on the upper end surface of the door to determine the user's intention to open the door.

FIG. 11 is a partial enlarged view of a vertical cross-section of the door illustrated in FIG. 5, showing a state in which the cover begins to move from the forwardmost position to the rearmost position.

FIG. 12 is a partial enlarged view of a vertical cross-section of the door illustrated in FIG. 5, showing a state in which the cover has been moved to the rearmost position.

FIG. 13 is a front perspective view of the door shown in FIGS. 3 and 4 when viewed from below.

FIG. 14 is an exploded perspective view of the light source module illustrated in FIG. 13.

FIG. 15 is a cross-sectional view showing a state in which the light source module is turned on while the door is moved to the rearmost position, where visible light irradiated from the light source module is reflected by the cover.

### DETAILED DESCRIPTION

Hereinafter, the present disclosure will be described with reference to drawings showing a configuration.

Hereinafter, the overall structure of a dish washer 1 will be described in detail with reference to the accompanying drawings.

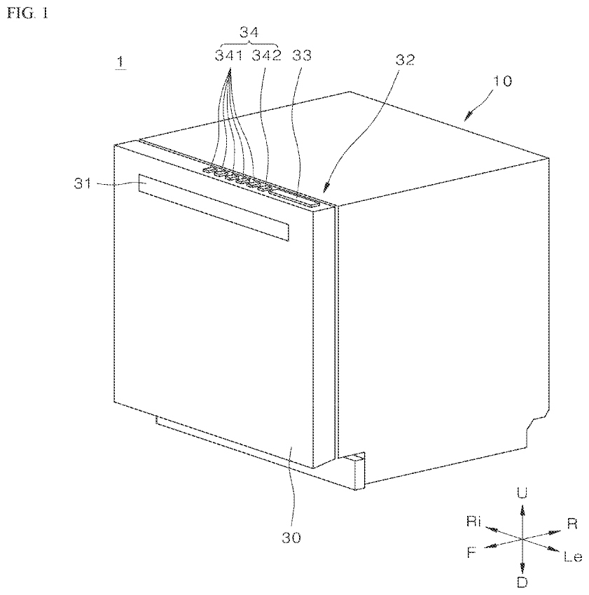

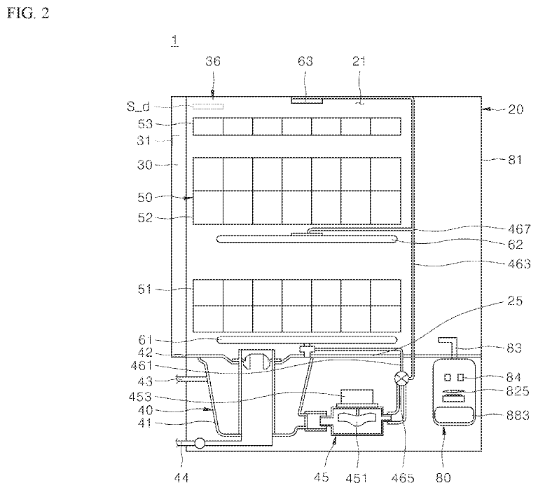

FIG. 1 is a front perspective view showing a dish washer, and FIG. 2 is a simplified cross-sectional view briefly showing the internal structure of the dish washer.

As shown in FIGS. 1 and 2, the dish washer 1 includes a case 10 forming an outer appearance; a tub 20 installed inside the case 10, forming a washing space 21 in which a wash target is washed, and having an open front surface; a door 30 opening and closing the open front surface of the tub 20; a drive part 40 which is located at the bottom of the tub 20, supplies, collects, circulates, and drains washing water for washing the wash target; a storage part 50 which is detachably provided in the internal washing space 21 of the tub 20 and in which the wash target is placed; and a spray part which is installed adjacent to the storage part 50 and sprays washing water for washing the wash target.

In this regard, the wash target placed in the storage part 50 may be, for example, tableware such as bowls, dishes, spoons, chopsticks and the like, and other cooking utensils. Unless otherwise stated below, the wash target will be referred to as tableware.

In some cases, the tub 20 may be formed in a box shape with the front surface open and may define a washing bath.

The washing space 21 is formed inside the tub 20, and the open front surface can be opened and closed by the door 30.

The tub 20 may be formed by pressing a metal plate that is resistant to high temperature and moisture, for example, a plate made of stainless steel series.

In addition, on the inner surface of the tub 20, there may be disposed a number of brackets for helping functional components such as the storage part 50, the spray part and the like to be described later to be supported and installed within the tub 20.

In some examples, the drive part 40 may include a sump 41 for storing the washing water, a sump cover 42 separating the sump 41 from the tub 20, a water supply part 43 supplying the washing water from the outside to the sump 41, a drain part 44 discharging the washing water of the sump 41 to the outside, and a washing pump 45 and a supply flow path 46 which supply the washing water from the sump 41 to the spray part. The sump cover 42 is disposed on the upper side of the sump 41, and can serve to separate the tub 20 from the sump 41.

In some implementations, the sump cover 42 may be provided with a plurality of recovery holes for recovering the washing water sprayed into the washing space 21 through the spray part into the sump 41.

That is, the washing water sprayed from the spray part toward the tableware may fall to the bottom of the washing space 21, and may be returned to the sump 41 through the sump cover 42.

The washing pump 45 is provided at one side of the sump 41, and serves to pressurize the washing water to supply it to the spray part.

The washing pump 45 may be connected to the sump 41 at its first end, and may be connected to the supply flow path 46 at its second end. The washing pump 45 may include an impeller 451 and a motor 453. When power is supplied to the motor 453, the impeller 451 rotates, and the washing water in the sump 41 can be pressurized and then supplied to the spray part through the supply flow path 46.

In some examples, the washing pump 45 may be provided with a washing water heater for heating the washing water supplied during a washing cycle or a heating and rinsing cycle.

In some examples, the supply flow path 46 can play a role to selectively supply the washing water supplied from the washing pump 45 to the spray part.

For example, the supply flow path 46 may include a first supply flow path 461 connected to the lower spray arm 61, a second supply flow path 463 connected to the upper spray arm 62 and the top nozzle 63, and the supply flow path 46 may be provided with a supply flow path switching valve 465 that selectively opens and closes the supply flow paths 461, 463.

In this regard, the supply flow path switching valve 465 may be controlled so that each of the supply flow paths 461, 463 is opened sequentially or simultaneously.

In some examples, the spray part is provided to spray washing water on tableware and the like stored in the storage part 50.

More specifically, the spray part may include a lower spray arm 61 located at the bottom of the tub 20 and spraying the washing water to the lower rack 51, an upper spray arm 62 located between the lower rack 51 and the upper rack 52 and spraying the washing water to the lower rack 51 and the upper rack 52, and a top nozzle 63 located at the top of the tub 20 and spraying the washing water to the top rack 53 or the upper rack 52.

In particular, the lower spray arm 61 and the upper spray arm 62 are rotatably provided in the washing space 21 of the tub 20 so that they can spray the washing water toward the tableware in the storage part 50 while rotating.

The lower spray arm 61 may be rotatably supported at the upper side of the sump cover 42 so that it can spray the washing water toward the lower rack 51 from the lower side of the lower rack 51 while rotating.

Additionally, the upper spray arm 62 may be rotatably supported by a spray arm holder 467 so that it can spray the washing water between the lower rack 51 and the upper rack 52 while rotating.

In some examples, a structure for diverting the washing water sprayed from the lower spray arm 61 in an up direction U-direction may be further provided at the bottom surface 25 of the tub 20 to increase the washing efficiency.

In some examples, the storage part 50 for storing the tableware may be provided in the washing space 21.

The storage part 50 can be withdrawable from the inside of the tub 20 through the open front surface of the tub 20.

For example, FIG. 2 shows an example which provides the storage part including the lower rack 51 located at the bottom of the tub 20 and capable of storing relatively large tableware, the upper rack 52 located at the upper side of the lower rack 51 and capable of storing medium-sized tableware, and the top rack 53 located at the top of the tub 20 and capable of storing small tableware and the like. The present disclosure will be described based on an example of the dish washer 1 having three storage parts 50 as illustrated, but not limited thereto.

These lower rack 51, upper rack 52 and top rack 53 can each be configured to be pulled out through the open front surface of the tub 20.

In some examples, on opposite side walls forming the inner surface of the tub 20, there may be guide rails, and for example, the guide rails 54 may include an upper rail, a lower rail, a top rail, and the like.

Wheels may be provided on the bottom of each of these lower racks 51, upper racks 52, and top racks 53. By pulling these lower rack 51, upper rack 52 and top rack 53 out through the front surface of the tub 20, the user can easily store tableware in them, or take out washed tableware from them.

The guide rail 54 may be provided with a fixed guide rail in the form of a simple rail for guiding the withdrawal and insertion of the storage part 50 or with a telescopic guide rail guiding the withdrawal and insertion of the storage part 50 and being capable of increasing the withdrawal distance according to withdrawal of the storage part 50.

In some examples, the door 30 has the purpose of opening and closing the open front surface of the tub 20.

A hinge part for opening and closing the door 30 is provided on the lower side of the front surface that is normally open, and the door 30 can be opened by rotating forward about the hinge part as a rotation shaft.

Here, the front panel 30a forming the outer surface of the door 30 may be provided with a handle 31 for opening the door 30 and a control panel 32 for controlling the operation of the dish washer 1.

In some implementations, the control panel 32 may be provided with a display 33 visually displaying information about the current operating status of the dish washer 1 and the like, and a button part 34 including a selection button for inputting a user's course selection operation, and a power button for inputting a user's operation for turning the dish washer on and off.

In some examples, a rear panel 30b forming the inner surface of the door 30 can form one surface of the tub 20 when the door 30 is closed while, at the same time, forming a seating surface on which the lower rack 51 of the storage part 50 can be supported when the door 30 is fully opened.

In some examples, when the door 30 is fully opened, the rear panel 30b of the door 30 can define a horizontal plane extending in the same direction as the guide rail 54 along which the lower rack 51 is guided.

In some implementations, the handle 31 of the dish washer 1 may be a recessed handle formed concavely toward the inside of the door 30 similar to a conventional one.

In this regard, as described later, a cover 35 may be further provided on the door 30 and configured to open and close an opening 30e of the front panel 30a that defines the entrance of the recessed handle 31.

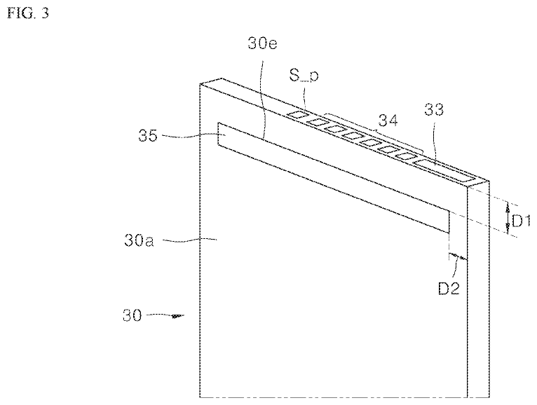

The detailed configuration of the handle 31 and the cover 35 will be described later with reference to FIG. 3 and below.

In some examples, a detergent supply device for automatically supplying detergent into the tub 20 may be disposed at the rear panel 30b forming the rear surface of the door 30.

In some examples, at the bottom of the tub 20, there may be provided a drying air supply part 80 for generating and supplying high-temperature or low-temperature drying air to the washing space inside the tub 20.

In some implementations, the drying air supply part 80 may be constructed by including a filter member 883 that filters outside air, a wind blowing fan 825 that generates a drying airflow, a heater 84 that heats the drying airflow, and an airflow guide 83 that is disposed at the inside of the tub 20 and guides the drying air flow.

In the lower surface of the tub 20, there may be provided a drying air supply hole to introduce high-temperature drying air generated from the drying air supply part 80 into the tub 20.

By supplying the high temperature drying air or the low temperature drying air through the drying air supply part 80 into the interior of the tub 20 during the drying process S5, the drying efficiency and sterilization effect on tableware can be improved compared to the conventional ones.

In some examples, the dish washer may be configured to discharge, to the outside, the airflow that has been supplied to the inside of the tub 20 and humidified while drying the tableware, and the discharge of the airflow may be accomplished through partial opening of the door 30 or through a separate exhaust.

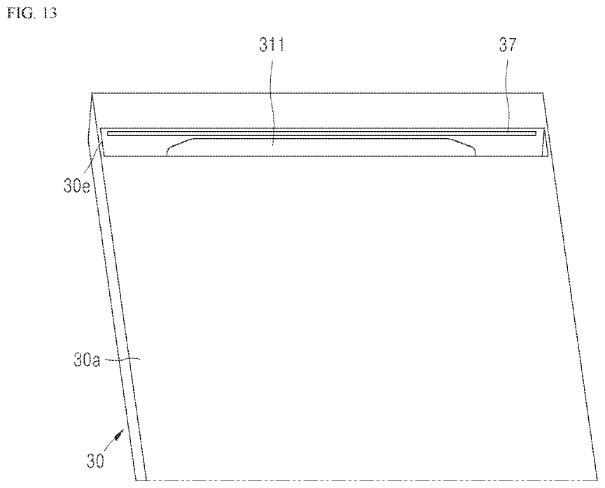

Hereinafter, with reference to FIGS. 3 to 15, the configuration of the handle 31, the cover 35, and a cover driver 36 provided on the door 30 of the dish washer 1 will be described in detail.

As described above, the inside of the door 30 of the dish washer 1 may be provided with the handle 31 configured to be held by the user when opening and closing the door 30.

Similarly to the conventional one, the handle 31 may be a recessed handle formed concavely toward the inside of the door 30 from the front panel 30a forming the front surface of the door 30.

In order to implement this recessed handle, a gripping groove 311 having an L-shaped cross-section may be provided on the rear of the front panel 30a of the door 30 to facilitate the user's grip.

For example, the gripping groove 311 may be a hollow part having an L shape formed inside a handle frame 30d.

In this regard, as described later, considering the L shape, the gripping groove 311 may be constructed by including a horizontal groove 3111 extending rearwardly from the opening 30e of the door 30 in a horizontal direction, and a vertical groove 3112 extending upwardly in a vertical direction from the upper end of the horizontal groove 3111 and disposed further rearward than the opening 30e of the door 30.

The front end surface of the horizontal groove 3111 of the gripping groove 311 is open so that the user's hand can easily enter the gripping groove 311 constituting the handle 31.

At a position in the front panel 30a, which corresponds to the open front end surface of the horizontal groove 3111 of the gripping groove 311, there may be formed an opening 30e extending long along a left and right direction of the door 30.

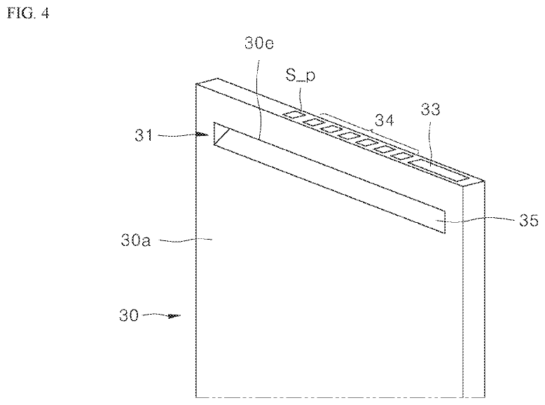

As shown in FIGS. 3 and 4, the gripping groove 311 and the opening 30e of the front panel 30a may be disposed at a position close to the upper end surface of the door 30 where the display 33 and button part 34 are disposed so that they can be easily gripped by the user in a standing-up state.

In more detail, considering the opening and closing movement of the door 30 that rotates around the lower end and considering the aesthetic feeling of the user, the opening 30e and the cover 35 that opens and closes the opening 30e can be disposed as close as possible to the upper end surface of the door 30.

For example, as shown in FIG. 3, the opening 30e may be disposed on the front panel 30a to form a predetermined up and down direction distance D1 from the upper end surface of the door 30.

Additionally, a predetermined left and right direction distance D2 can be formed between the opening 30e and the right side surface or the left side surface of the door 30.

In some implementations, as shown in FIG. 3, the up and down direction distance D1 between the opening 30e and the upper end surface of the door 30 can be greater than the left and right direction distance D2 between the opening and the right side surface or the left side surface of the door 30.

By setting the up and down direction distance D1 greater than the left and right direction distance D2 in this way, a certain amount of free space can be secured between the opening 30e and the upper end surface of the door 30, so that the user's accessibility and convenience of operation for the button part 34 disposed on the upper end surface of the door 30 can be improved somewhat.

In addition, the dish washer 1 may further include the cover 35 for opening and closing the open front end surface of the gripping groove 311 and the opening 30e of the front panel 30a.

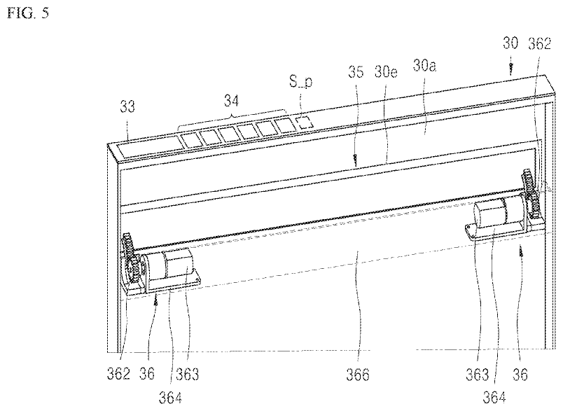

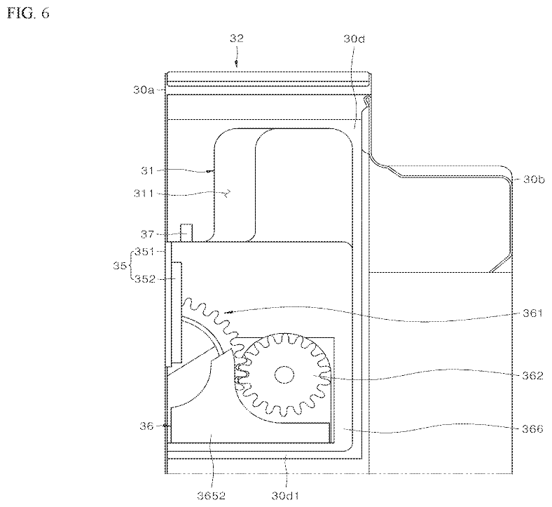

As shown in FIGS. 5 and 6, the cover 35 plays a role to close the opening 30e of the front panel 30a and the front end surface of the gripping groove 311 in a situation where the door 30 is not being used, and to open the opening 30e of the front panel 30a and the front end surface of the gripping groove 311 in a situation where the door 30 is being used.

In some examples, the cover 35 may be disposed to automatically move back and forth between a position where it is moved most forward and a position where it is moved most rearward according to the operation of the cover driver 36 to be described later.

For convenience, in the following description, the position where the cover 35 is moved most forward is defined as the forwardmost position, and the position where the cover 35 is moved most rearward is defined as the rearmost position. For instance, a front surface of the cover 35 at the forwardmost position can be flush with the front surface of the door and define one plane with the front surface of the door.

Accordingly, the accumulation of external foreign substances such as dust inside the gripping groove 311 constituting the handle 31 of the dish washer 1 can be minimized, and the contamination of the gripping groove 311 can be minimized.

In order for the user's grip to be easily implemented, the cover 35 may be implemented as a retractable type in which it is disposed inside the gripping groove 311, i.e., inside the horizontal groove 3111, to be rotatable around its lower end.

As the cover 35 is provided in an internally retractable type in this way, the cover 35 has no portion that protrudes forward from the door 30, and the possibility of injury to the user or damage to the cover 35 that would occur if the cover 35 is provided in a protruding type can be reduced.

The cover 35 may be rotatably supported by a rack gear part 361 connected to the rear surface of the cover 35 so as not to interfere with the user's grip on the L-shaped gripping groove 311 during the retracting process, while being disposed in the retractable type in which it is rotatably disposed within the gripping groove 311.

Accordingly, as described later, when the user's intention to open the door 30 is confirmed at a time when the door 30 needs to be opened and closed, and the cover driver 36 is started to operate, similar to the door 30, the cover 35 rotates backwards around the lower end from the forwardmost position shown in FIG. 6 to the rearmost position, thereby opening the gripping groove 311.

In some examples, the backward rotation of the cover 35 can proceed to the front end of the first guide groove 3651c and the front end of the second guide groove 3652c of the rack holder 365 that define the rotation range of the rack gear part 361.

Accordingly, the opening 30e of the front panel 30a of the door 30 can become the front limit that defines the forwardmost position of the cover 35, and the front end of the first guide groove 3651c and the front end of the second guide groove 3652c of the rack holder 365 can become the rear limit that define the rearmost position of the cover 35.

In some examples, when the cover 35 is moved to the rear limit as described later, the inclination angle of the cover 35 with respect to the horizontal direction may be approximately 45 degrees. Accordingly, the rotation angle range of the cover 35 can be defined as 45 degrees or more and 90 degrees or less with respect to the horizontal direction.

FIGS. 6 to 9 illustrate detailed configurations of the cover 35 and the cover driver 36.

First, referring to FIGS. 6 to 8, the cover 35 may be, by way of example, constructed by including a first cover body 351 having an outer appearance corresponding to the opening 30e of the front panel 30a, and a second cover body 352 attached to the rear surface of the first cover body 351.

The first cover body 351 serves to form the overall outer appearance of the cover 35.

In accordance with the shape of the opening 30e of the front panel 30a, the first cover body 351 may be provided in a plate shape whose left and right direction width is greater than the up and down direction width.

The second cover body 352 is attached to the rear surface of the first cover body 351 to reinforce the overall rigidity of the cover 35, and serves to rotatably support the first cover body 351.

In some examples, one end of the rack gear part 361 constituting the cover driver 36 to be described later may be connected to the rear surface of the second cover body 352.

Accordingly, the rack gear part 361 moves according to the forward rotation or backward rotation of the cover 35 together with it as one piece.

In some examples, the cover 35 may further include a decorative panel attached to the front surface of the first cover body 351.

The decorative panel is attached to the front surface of the first cover body 351, and serves to form the front end surface of the cover 35.

In this regard, the decorative panel may be formed with a material having the same texture as the front panel 30a of the door 30.

Through this, a sense of unity can be formed between the decorative panel and the front panel 30a of the door 30, the aesthetic sensibility to the outer appearance of the door 30 can be improved, and the aesthetic feeling of the user can be improved.

In addition, as shown in FIG. 6, when the cover 35 is rotated to the forwardmost position, the decorative panel may be in a state parallel to the front panel 30a so as to form a continuous surface with the front panel 30a of the door 30.

That is, it may be configured so that no step is formed between the front panel 30a of the door 30 and the front end surface of the cover 35.

Through this, when the cover 35 is rotated to the forwardmost position, the opening 30e of the front panel 30a is completely blocked, and since no step is formed between the front panel 30a and the decorative panel, the phenomenon of foreign substances such as dust accumulating in the convex part of the door 30 or on the handle itself, as in the conventional one, can be fundamentally prevented.

In some examples, where the first cover body 351 forms the front end surface of the cover 35 without adding a decorative panel as illustrated, the surface of the first cover body 351 may be treated to have a material having the same texture as the front panel 30a of the door 30, and the first cover body 351 may be disposed to be parallel to the front panel 30a of the door 30 to form a continuous surface.

In some examples, the cover driver 36 serves to reciprocate the cover 35 between the forwardmost position and the rearmost position.

Referring to FIG. 5, considering the shape of the cover 35 that extends long in a left and right direction, a pair of cover drivers 36 may be disposed in a separated state on the left end side and the right end side of the cover 35, for example.

That is, a pair of cover drivers 36 may be disposed in a spaced and separated state along a left and right direction so that a drive force for reciprocating the cover 35 can be transmitted to the left and right ends of the cover 35 which is disposed in a state of being accommodated inside the gripping groove 311 of the handle frame 30d, respectively.

In this way, as a pair of cover drivers 36 are disposed in a separated state from each other along a left and right direction, the drive force generated from each cover driver 36 can be transmitted to the cover 35.

Accordingly, the drive load applied to the individual cover driver 36 is distributed, enabling miniaturization of the individual cover driver 36, which can have the effect of reducing manufacturing costs.

This is one example. In some examples, it is also possible to configure the cover 35 to be driven by a single cover driver. The present disclosure is not limited thereto, but will be described below based on an example in which a pair of cover drivers 36 are provided.

In some examples, the cover driver 36 on the left side and the cover driver 36 on the right side have symmetrical shapes and can be installed and fixed to the handle frame 30d through their housings 366 in a state where they are arranged symmetrically with respect to the cover 35.

Therefore, the cover drivers 36 can be configured identically to each other except that they have a symmetrical shape and are arranged symmetrically.

Therefore, the following description will be based on the cover driver 36 disposed on the left side, and unless otherwise stated, the following contents may be equally applied to the cover driver 36 disposed on the right.

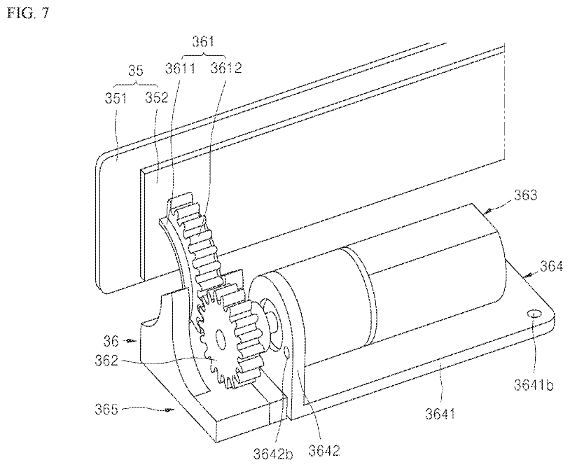

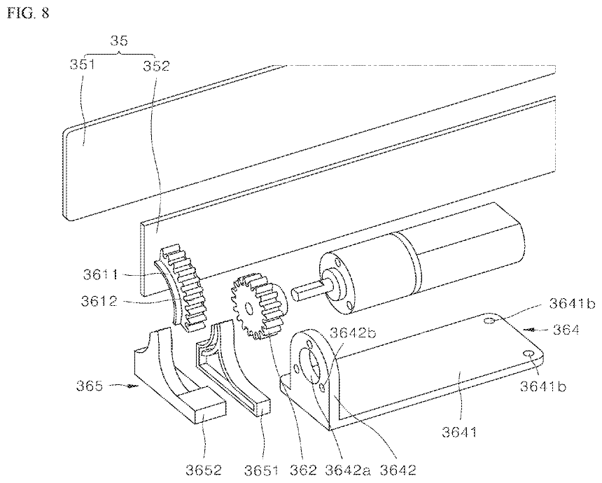

As shown in FIGS. 7 and 8, the cover driver 36 that generates a drive force to reciprocate the cover 35 may be constructed by including a drive motor 363 that receives power and generates a rotational drive force, a drive gear 362 that is rotated by the rotational drive force of the drive motor 363, a rack gear part 361 which is connected to the cover 35 at its one end to rotate together with the cover 35, and has a rack gear 3612 meshed with the drive gear 362, a rack holder 365 that prevents the rack gear part 361 from deviating from its course and guides the rotation direction and rotation range of the rack gear part 361, and a housing 366 accommodating the drive motor 363 and rack holder 365.

The drive motor 363 serves to be supplied with power to generate rotational drive force.

As described above, the cover 35 may be configured to repeatedly move back and forth between the forwardmost position and the rearmost position.

To easily implement such reciprocating movement, the drive motor 363 constituting the cover driver 36 may be configured to generate bidirectional rotational drive forces.

Accordingly, there is no limitation to the type of the drive motor 363 applied to the cover driver 36 as long as it is a motor capable of generating bidirectional rotational drive forces.

Hereinafter, among the bidirectional rotational drive forces, the drive in the direction in which the output shaft 3632 of the drive motor 363 rotates to move the cover 35 backward toward the rearmost position is referred to as forward rotational drive or forward rotational drive force, and the drive in the direction in which the output shaft 3632 of the drive motor 363 rotates to move the cover 35 forward toward the forwardmost position is referred to as backward rotational drive or backward rotational drive force.

In some examples, as shown in FIGS. 7 and 8, the motor body 3631 of the drive motor 363 may be fixed to and supported by the first bracket 3641 of the motor bracket 364 installed in the housing 366, and the output shaft 3632 of the drive motor 363 may pass through the second bracket 3642 of the motor bracket 364 to be connected to the drive gear 362.

In some implementations, in the first bracket 3641 of the motor bracket 364, there may be formed a plurality of bolt holes 3641b penetrating through it for fastening it to the housing 366.

In addition, in the second bracket 3642 of the motor bracket 364, there may be formed a coupling hole 3642a penetrating through it, through which the output shaft 3632 of the drive motor 363 passes and into which the leading end of the drive motor 363 can be inserted and coupled, and there may be formed a plurality of bolt holes 3642b penetrating it around the coupling hole 3642a for fastening it to the drive motor 363.

In the leading end of the drive motor 363 where the output shaft 3632 is disposed, there may be provided bolt grooves 3631a at corresponding positions to the bolt holes 3642b of the second bracket 3642.

The output shaft 3632 of the drive motor 363 can be inserted into the shaft hole of the drive gear 362 and be forcibly coupled to the shaft hole.

Through this, the output shaft 3632 of the drive motor 363 can be rotated integrally with the drive gear 362.

In some examples, the rack gear part 361 serves to transmit the rotational drive force of the drive gear 362 to the cover 35 to be described later while rotating together with the cover 35.

In order to be able to rotate together with the cover 35, one end of the rack body 3611 of the rack gear part 361 may be a fixed end integrally connected to the rear surface of the second cover body 352 of the cover 35, and the other end thereof may be a free end.

In addition, in order to rotate in conjunction with the rotation of the cover 35 while minimizing the space occupied by the rack gear part 361, the rack body 3611 may be configured to have a cylindrical surface shape with a cross-section that is an arc shape.

In this regard, the rack body 3611 may be provided so that the center of curvature of the arc shape is formed at the lower end of the cover 35. Through this, the entire rotation center of the cover 35 can be formed at the lower end of the first cover body 351 or the lower end of the second cover body 352, and the formation of a gap between the lower end of the cover 35 and the opening 30e of the door 30 during the rotation of the cover 35 can be minimized.

In some examples, on the outer circumferential surface of the rack body 3611, there may be integrally provided a rack gear 3612.

As described above, the rack gear 3612 may be meshed with the drive gear 362.

Accordingly, a state can be formed in which the rack body 3611 rotates in conjunction with the drive gear 362 by the rack gear 3612 or is prevented from rotating in conjunction with the drive gear.

In some examples, the left and right direction width of the rack gear 3612 can be formed smaller than the left and right direction width of the rack body 3611. Accordingly, on the outer circumferential surface of the rack body 3611, a portion where the rack gear 3612 is not formed can be formed near each of the opposite side edges.

The outer circumferential surface portion of the rack body 3611 where the rack gear 3612 is not formed in this way can be inserted into the first guide groove 3651c and the second guide groove 3652c of the rack holder 365 to be described later, so that the rotation direction and rotation range of the rack gear part 361 can be guided.

In some examples, the rack holder 365 serves to prevent the rack gear part 361 from deviating from its course during the rotation process of the rack gear part 361 and to guide the rotation direction and rotation range of the rack gear part 361.

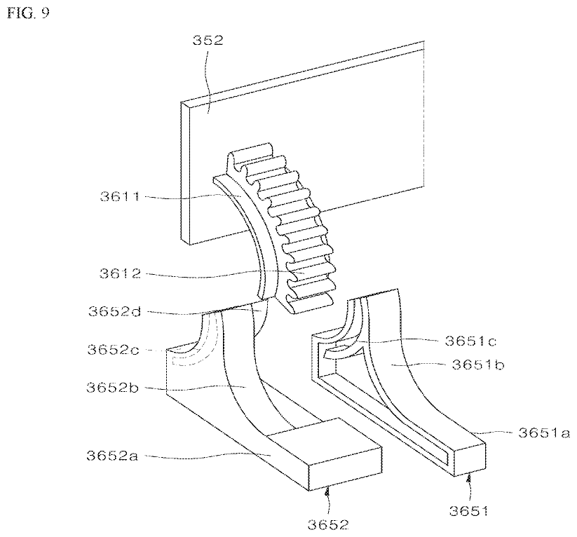

More specifically, as illustrated in FIGS. 8 and 9, the rack holder 365 may be provided as a pair of split bodies formed by splitting along a front and rear direction with the rack gear part 361 as the center in order to increase the support effect for the relatively moving rack gear part 361 and to consider the convenience of assembly.

Hereinafter, among the pair of split bodies, the one positioned closer to the drive motor 363 will be referred to as the first holder 3651, and the one positioned further away from the drive motor 363 will be referred to as the second holder 3652.

In some implementations, the first holder 3651 may be constructed by including a first base 3651a fixed to the housing 366 and disposed below the rack gear part 361, and a first guide part 3651b extending upward from the first base 3651a toward the rack gear part 361.

The first guide part 3651b may be provided in a spire shape whose cross-sectional area gradually decreases as it advances in the upward direction In, so that it can correspond to the cylindrical shape of the rack gear part 361 and prevent interference with the drive gear 362.

The second holder 3652 may be constructed by including a second base 3652a fixed to the housing 366 and disposed below the rack gear part 361, and a second guide part 3652b extending upward from the second base 3652a toward the rack gear part 361.

The second guide part 3652b may be provided in a spire shape whose cross-sectional area gradually decreases as it advances in the upward direction In, so that it can correspond to the cylindrical shape of the rack gear part 361 and prevent interference with the drive gear 362.

In this regard, the first holder 3651 and the second holder 3652 can be coupled with each other so that the first guide part 3651b and the second guide part 3652b are spaced apart from each other by a predetermined distance to support the rack gear part 361 while sandwiching it between the first guide part 3651b of the first holder 3651 and the second guide part 3652b of the second holder 3652. The size of the predetermined interval may correspond to the left and right direction width of the rack gear 3612.

As described above, in the first guide part 3651b of the first holder 3651 and the second guide part 3652b of the second holder 3652, the first guide groove 3651c and the second guide groove 3652c may be concavely formed respectively, into which the outer circumferential surface portions of the rack body 3611 on which the rack gear 3612 is not formed are inserted to be coupled to them.

Accordingly, when the first holder 3651 and the second holder 3652 are coupled to the rack gear part 361, the outer circumferential surface portions of the rack body 3611 on which the rack gear 3612 is not formed are inserted into the first guide groove 3651c of the first guide part 3651b and the second guide groove 3652c of the second guide part 3652b, so that the rack gear part 361 can be supported by the rack holder 365 with the rack gear 3612 exposed to the outside of the rack holder 365.

Through this, the rack gear part 361 can be supported in a state where it can move or rotate relative to the rack holder 365.

In order to support the rack gear part 361 while allowing it to be relatively movable in this way, the first guide groove 3651c and the second guide groove 3652c may be formed to have a thickness greater than or equal to the thickness of the rack body 3611 and may be formed to have a curvature equal to the curvature of the rack body 3611.

In some examples, the rack holder 365 may serve as a stopper which defines the rearmost position within the rotation range of the cover 35 and the rack gear part 361.

In order to be able to define the rearmost position of the cover 35 and the rack gear part 361, the lower end of the first guide groove 3651c and the lower end of the second guide groove 3652c may not be open but blocked.

Therefore, in order to open the gripping groove 311, when the cover 35 and the rack gear part 361 are moved to the rearmost position after the forward rotational movement of the cover 35 and the rack gear part 361 has been initiated, the free end of the rack body 3611 of the rack gear part 361 collides with the blocked lower end of the first guide groove 3651c and the blocked lower end of the second guide groove 3652c, so that the forward rotational movement of the cover 35 and the rack gear part 361 can be stopped.

In some examples, the upper end of the first guide groove 3651c and the upper end of the second guide groove 3652c may be opened so that the forward and backward rotational movements of the rack gear part 361 can proceed smoothly.

In some examples, a reinforcing rib 3652d having a shape corresponding to the shape of the inner circumferential surface of the rack body 3611 may be integrally formed in at least one of the first guide part 3651b of the first holder 3651 and the second guide part 3652b of the second holder 3652.

The reinforcing rib 3652d may be configured to make surface contact with the inner circumferential surface of the rack body 3611 so that it can serve to improve the coupling strength and support strength of the rack holder 365 for the rack gear part 361.

In some examples, the reinforcing rib 3652d may be provided in a cylindrical shape having a shape and a curvature which correspond to the inner circumferential surface of the rack body 3611 of the rack gear part 361.

FIG. 7 and below illustrate an example in which the reinforcing rib 3652d is provided on the front edge of the second guide part 3652b, but the present disclosure is not limited thereto, and a configuration in which a reinforcing rib 3652d is provided on the front edge of the first guide part 3651b is also considered to fall within the scope of the present disclosure.

In some examples, the dish washer 1 may further be provided with a device for sensing a user's intention to open the door 30.

For example, the dish washer 1 may include a proximity sensor S_p for sensing a user's intention to open the door 30.

The proximity sensor S p may be a sensor that can sense whether a user is nearly within a specific sensing range from the door 30.

For example, the proximity sensor S_p may include any one of a radar sensor, an image sensor, or an infrared IR sensor.

However, the present disclosure is not limited to this, but can employ, without limitation, any devices as long as they can detect the proximity of a user. In the following, a description will be given based on an example in which a radar sensor is applied as a proximity sensor S_p.

As shown in FIGS. 3 to 5, in order to easily confirm whether a user is approaching the front region of the door 30 and to facilitate modularization with the existing display 33 or the like, a radar sensor as a proximity sensor S_p may be dispose at the control panel 32 in a position close to the display 33.

Further, in order to distinguish between users and non-users such as pets to recognize them, the radar sensor functioning as the proximity sensor S_p can be configured to be disposed on the control panel 32 at a position as close as possible to the center of the upper side surface of the door 30.

In some examples, the dish washer 1 is not configured so that the cover 35 moves immediately even when a user is recognized by the radar sensor to be within a predetermined sensing range from the door 30.

This is because there may be cases where a user simply passes by the dish washer 1 without the intention to open the door 30.

Therefore, a time condition may be additionally added to confirm the intention to open the door 30 through the proximity sensor S p such as the radar sensor.

That is, if it is confirmed through the radar sensor that the user exists within a specific distance range from the door 30 and continues to stay within the specific distance range or sensing range for a specific time condition, it can be determined that the user has the intention to open the door 30.

Here, the specific distance range and the specific time condition may be set differently depending on the environment in which the dish washer 1 is placed, the physical condition of the user or the like.

In this way, when the specific distance range condition and the specific time condition are satisfied, the operation of the cover driver 36 is initiated, so that the cover 35 can be moved backward from the forwardmost position to the rearmost position.

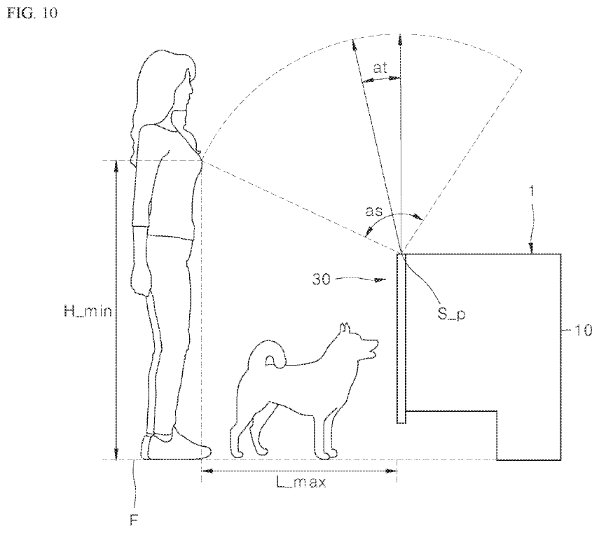

FIG. 10 discloses a configuration for sensing a user's intention to open the door 30 using a single radar sensor as a proximity sensor S_p.

In some implementations, a radar sensor can perform the function of sensing the presence of a user or an object within a sensing region (“as”), the distance to the user or object, and the moving speed of the user or object by a sensing surface S_pl transmitting electromagnetic waves and analyzing reflected electromagnetic waves which have collided with the user or object.

As described above, the sensing region as of the radar sensor applied to the present disclosure may have an angular range of 100 degrees more or less in a front and rear direction and 100 degrees more or less in a left and right direction based on the sensing surface S_pl.

In this regard, as described above, in order to easily confirm whether a user is approaching the front region of the door 30 and to distinguish between users and non-users such as pets to recognize them, the radar sensor functioning as the proximity sensor S_p may be configured to be disposed as close as possible to the center of the upper side surface of the front panel 30a of the door 30 as the inside of the door 30.

In addition, as illustrated in FIG. 10, since the radar sensor is disposed inside the door 30 close to the upper side surface of the front panel 30a of the door 30, the sensing surface S_pl of the radar sensor can be arranged to generally face the upper side of the door 30.

Furthermore, the sensing surface S_pl of the radar sensor can be arranged in a tilted state at a predetermined angle toward the front of the door 30.

Therefore, the sensing surface S_pl of the radar sensor can be arranged to face the front upper side of the door 30.

As described above, by disposing the sensing surface S_pl of the radar sensor in a tilted state so as to face the front upper side of the door 30 rather than the front lower side of the door 30, the sensing region as of the radar sensor can be formed in a state where it is tilted toward the front upper side of the door 30.

By disposing the sensing surface S_pl of the radar sensor in a tilted state in a tilting holder 30f3 so that it faces the front upper side of the door 30, the radar sensor can be configured so that even when an object that cannot be expected to use the dish washer 1, such as a pet or a child with a stature smaller than that of the dish washer 1, approaches the front of the door 30, the radar sensor cannot sense it.

Accordingly, the cover 35 is prevented from operating in vain by sensing pets or children, and thus power loss can be minimized.

Here, the tilting angle (“at”) of the sensing surface S_pl of the radar sensor with respect to the vertical direction may be, for example, 25 degrees or more and 35 degrees or less. In some implementations, the tilting angle at can be 30 degrees or less.

In some examples, the tilting angle at of the sensing surface S_pl of the radar sensor provided in the present disclosure with respect to the vertical direction can be adjusted according to the physical condition of the user who is expected to use the dish washer 1.

For example, when the tilting angle at of the sensing surface S_pl of the radar sensor with respect to the vertical direction is set to 30 degrees, the minimum vertical sensing height H_min of the radar sensor can be 100 cm or more and 110 cm or less, e.g., 105 cm, and the maximum sensing distance L_max based on the horizontal direction can be 75 cm or more and 85 cm or less, e.g., 80 cm.

That is, when the tilting angle at is set to 30 degrees, a user with a stature of 105 cm or more can be recognized as being in proximity if he or she comes within the sensing range of 80 cm from the radar sensor in the horizontal direction.

In contrast, for example, when the tilting angle at is set to 15 degrees, a user with a stature of 127 cm or more can be recognized as being in proximity if he or she comes within the range of 50 cm of the radar sensor in the horizontal direction.

In some examples, the dish washer 1 may further include a light source module 37 which functions as a lighting device that irradiates visible light toward the internal space of the gripping groove 311.

To effectively illuminate the inside of the gripping groove 311 and minimize the direct irradiation of the generated visible light to the outside of the door 30, the light source module 37 may be disposed at the handle frame 30d forming the gripping groove 311.

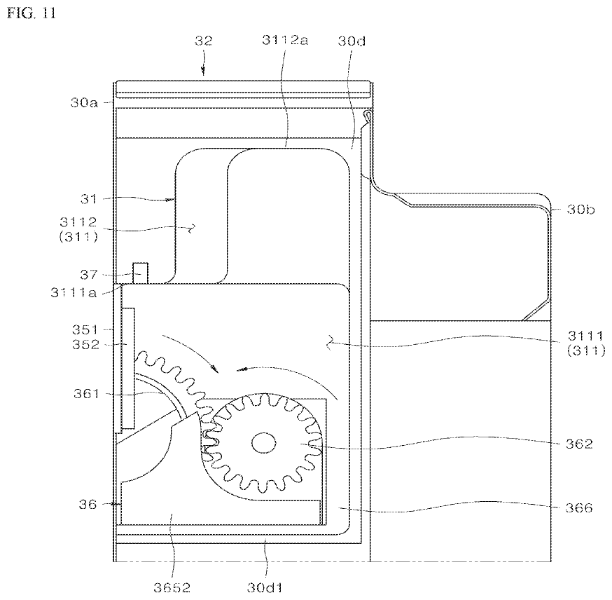

More specifically, as illustrated in FIGS. 11 to 13, the light source module 37 may be disposed on the upper end surface 3111a of the horizontal groove 3111 formed between the opening 30e of the door 30 and the vertical groove 3112 of the gripping groove 311 in the horizontal direction.

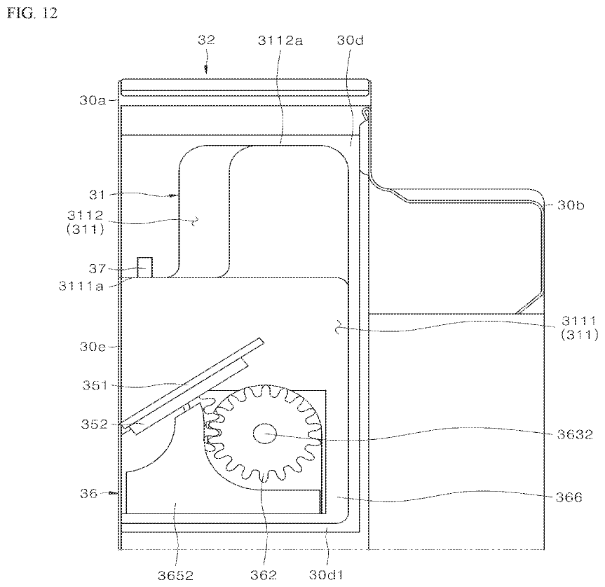

Through this, the light source module 37 can be disposed between the opening 30e of the door 30 and the vertical groove 3112 of the gripping groove 311, and as shown in FIG. 12, when the cover 35 is rotated to the rearmost position, the light source module 37 can be disposed between the upper end edge and the lower end edge of the cover 35 in the horizontal direction. In some examples, the light source module 37 can be disposed closer to the front surface of the door than to a rear surface of the door, where the gripping groove 311 is defined between the front surface of the door than to the rear surface of the door.

In some implementations, some of the visible light generated from the light source module 37 is reflected by the front end surface of the cover 35 to passe through the opening 30e and illuminate the outside of the door 30, and the remaining portion thereof can be reflected toward the horizontal groove 3111 and the vertical groove 3112.

In some implementations, as illustrated in FIGS. 11 to 13, the light source module 37 is disposed at the upper end surface 3111a of the horizontal groove 3111 of the gripping groove 311 which has a relatively narrow front and rear direction width compared to the front and rear direction width of the vertical groove 3112, so the light source module 37 may be provided in a rod shape in which the front and rear direction width and the up and down direction height are much smaller than the left and right direction width.

In addition, as shown in FIGS. 11 to 13, the light source module 37 may be disposed so as to be embedded in the upper end surface 3111a of the horizontal groove 3111 of the gripping groove 311.

In this regard, the position where the light source module 37 is disposed may be in a place where it directly contacts the user's finger when the user grips.

In order to prevent injuries that may occur due to direct contact with the user's fingers and to improve the grip feeling when gripping, the lower end of the light source module 37 may be disposed in a completely buried state in the upper end surface 3111a of the horizontal groove 3111 of the gripping groove 311 so that no portion protrudes from the upper end surface 3111a of the horizontal groove 3111.

Through this, there can be formed a state where no step is formed between the lower end of the light source module 37 and the upper end surface 3111a of the horizontal groove 3111 of the gripping groove 311.

In some examples, the light source module 37 may be linearly extended long along the extension direction of the opening 30e of the door 30.

In some examples, in order to prevent interference with other parts and ensure assembly of the handle frame 30d of the light source module 37, the left and right direction width of the light source module 37 may be equal to or slightly smaller than the left and right direction width of the opening 30e of the door 30 and the left and right direction width of the cover 35.

In some examples, in order to illuminate the entire inside of the gripping groove 311, and especially to enhance the illumination effect for the vertical groove 3112, the left and right direction width of the light source module 37 may be made greater than the left and right direction width of the vertical groove 3112.

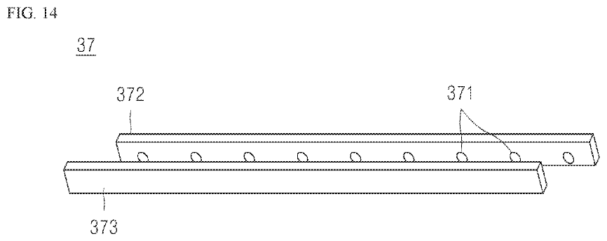

FIG. 14 illustrates an exemplary detailed structure of the light source module 37 described above.

Referring to FIG. 14, the light source module 37 may further include at least one light source element 371 receiving power to generate visible light, a substrate 372 on which at least one light source element is mounted, and a light guide plate 373 disposed parallel to the substrate 372 and diffusing visible light generated from the light source element 371.

In some examples, the light source module 37 may further be provided with a module case for accommodating and protecting the substrate 372 and the light guide plate 373.

The light source element 371 generates light or visible light when the cover 35 moves and before the movement is initiated, thereby visually informing the user that the cover 35 and the cover driver 36 are operating normally.

The light source element 371, which is configured to receive power to generate a predetermined amount of visible light, can include various types of light source elements such as, for example, one or more LED elements.

The present disclosure will be described below based on, but not limited to, an example in which an LED element is applied as the light source element 371.

In FIG. 14, a configuration is illustrated in which a total of 10 LED elements are mounted in a line on a substrate 372 considering the left and right direction width of the light source module 37, but the present disclosure is not limited thereto, and the number of LED elements may be increased or decreased depending on the size and shape of the cover 35 and the gripping groove 311.

In some examples, the light guide plate 373 serves to diffuse visible light generated from the light source element 371.

More specifically, based on the disposed state, visible light generated from the light source element 371 can be introduced through the upper surface of the light guide plate 373 and then dispersed within the light guide plate 373 to be diffused toward the lower surface of the light guide plate 373.

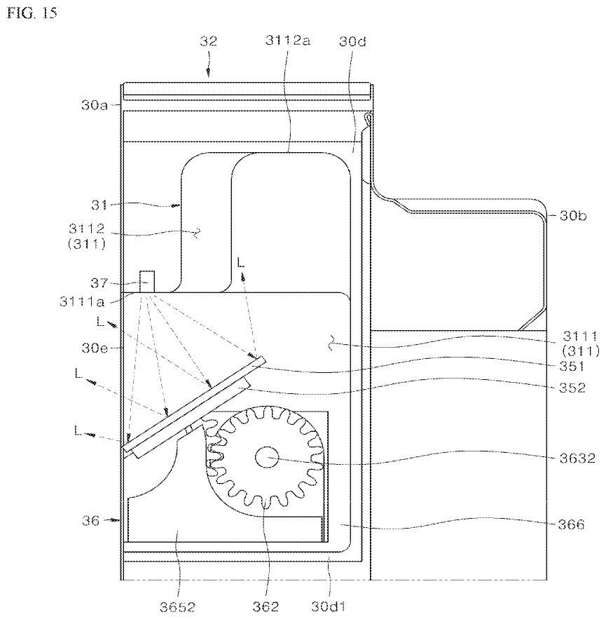

In addition, as described above, since the light source module 37 is disposed in a state where it is completely embedded in the handle frame 30d except for the lower surface of the light guide plate 373, the light generated from the light source element 371 can pass through, as illustrated in FIG. 15, the lower surface of the light guide plate 373 by way of the inside of the light guide plate 373 to be projected effectively toward the horizontal groove 3111 of the gripping groove 311.

Through the visible light projected through the lower surface of the light guide plate 373 as described above, the user can effectively check the information that the cover 35 and the cover driver 36 will soon start operating or that they are operating normally.

In order for the user to effectively receive the information that the cover 35 and the cover driver 36 are operating normally or that their operation will be soon initiated, the light source module 37 can be turned on before the cover driver 36 moves the cover 35 from the forwardmost position to the rearmost position, or can be turned on at the same time when the cover driver 36 moves the cover 35 from the forwardmost position to the rearmost position.

FIG. 15 illustrates a state in which the visible light is irradiated into the inside of the gripping groove 311 through the light source module 37, with the cover 35 rotated to the rearmost position.

As described above, when the cover 35 is rotated to the rearmost position, the light source module 37 can be positioned between the upper end edge and the lower end edge of the cover 35 in the horizontal direction.

Additionally, when the cover 35 is moved to the rearmost position, the cover 35 forms an inclination angle of approximately 45 degrees with respect to the horizontal direction.

Accordingly, as illustrated, a portion of the visible light irradiated through the light guide plate 373 of the light source module 37 is reflected by the front end surface of the cover 35 and passes through the opening 30e to be irradiated to the outside of the door 30, and the user can intuitively recognize that the cover 35 has moved to the rearmost position, so that gripping through the gripping groove 311 is possible.

Additionally, the remaining portion of the visible light irradiated through the light guide plate 373 of the light source module 37 is reflected toward the inside of the gripping groove 311.

In particular, since the visible light can be reflected toward the upper end surface 3111a of the horizontal groove 3111 of the gripping groove 311 and the upper end surface 3112a of the vertical groove 3112, the user can intuitively check the position of the vertical groove 3112 when gripping to open the door 30, so that the user's convenience can be improved.

Although the present disclosure has been described with reference to the drawings as examples, the present disclosure is not limited to the implementations and drawings disclosed in this specification, and that various modifications can be made by those skilled in the art without departing from the scope of the technical idea of the present disclosure. In addition, even if the effects according to the configuration of the present disclosure were not explicitly written while describing the implementations of the present disclosure, it is natural that the effects that can be predicted by the configuration should also be recognized.

1-15. (canceled)

16. A dish washer, comprising:
a tub that defines a washing space configured to accommodate tableware, the tub having an open front side;
a door configured to rotate relative to the tub to thereby open and close the open front side of the tub, the door having an opening defined at a front surface of the door;
a handle that includes a gripping groove that extends from the opening in the front surface of the door toward an inside of the door, the gripping groove being configured to be gripped by a user to open and close the door;
a cover configured to rotate toward the inside of the door relative to the front surface of the door to thereby open and close the opening of the door; and
a light source that is disposed inside the door and faces the gripping groove, the light source being configured to emit visible light toward at least a portion of the gripping groove.

17. The dish washer of claim 16, wherein the gripping groove comprises:
a horizontal groove that extends from the opening of the door rearwardly in a horizontal direction; and
a vertical groove that extends from an upper end of the horizontal groove upwardly in a vertical direction, the vertical groove being disposed rearward relative to the opening of the door, and
wherein the light source is disposed forward relative to the vertical groove.

18. The dish washer of claim 17, wherein the light source is disposed between the opening of the door and the vertical groove.

19. The dish washer of claim 17, wherein the light source is disposed at a height corresponding to the upper end of the horizontal groove.

20. The dish washer of claim 19, wherein a lower end of the light source is disposed inside the door such that no part of the light source protrudes to an upper end surface of the horizontal groove.

21. The dish washer of claim 20, wherein the lower end of the light source is flush with the upper end surface of the horizontal groove.

22. The dish washer of claim 16, wherein the light source extends linearly along an extension direction of the opening of the door.

23. The dish washer of claim 22, wherein a width of the light source in a left-right direction of the door is greater than a width of the gripping groove in the left-right direction.

24. The dish washer of claim 22, wherein a width of the light source in a left-right direction of the door is less than a width of the opening in the left-right direction.

25. The dish washer of claim 22, wherein a width of the light source in a left-right direction of the door is less than a width of the cover in the left-right direction.

26. The dish washer of claim 16, further comprising a cover driver configured to rotate the cover between a forwardmost position of the cover and a rearmost position of the cover relative to the front surface of the door.

27. The dish washer of claim 26, wherein the light source is configured to turn on before the cover driver moving the cover from the forwardmost position to the rearmost position.

28. The dish washer of claim 26, wherein the light source is configured to turn on simultaneously with an operation of the cover driver for moving the cover from the forwardmost position to the rearmost position.

29. The dish washer of claim 26, wherein the cover is configured to, based on the cover being moved to the rearmost position by the cover driver, reflect a first portion of the visible light toward an outside of the door.

30. The dish washer of claim 29, wherein the cover is configured to, based on the cover being moved to the rearmost position by the cover driver, reflect a second portion of the visible light toward the gripping groove.

31. The dish washer of claim 26, wherein the forwardmost position of the cover is flush with the front surface of the door.

32. The dish washer of claim 26, wherein the light source is configured to be disposed rearward relative to a rear surface of the cover based on the cover being moved to the forwardmost position by the cover driver.

33. The dish washer of claim 26, wherein the cover driver comprises a drive motor that is disposed inside the gripping groove.

34. The dish washer of claim 16, wherein the light source comprises a substrate and one or more light emitting diodes that are arranged on the substrate along the opening of the door.

35. The dish washer of claim 16, wherein the light source is disposed closer to the front surface of the door than to a rear surface of the door.
